(19) United States
(12) Patent Application Publication
(10) Pub. No.: US 2021/0033417 A1
(43) Pub. Date: Feb. 4, 2021

(54) CURSOR LOCATION ON A NAVIGATIONAL MAP

(71) Applicant: NOKIA TECHNOLOGIES OY, Espoo (FI)

(72) Inventor: Arto Kristian SUVITIE, Helsinki (FI)

(73) Assignee: NOKIA TECHNOLOGIES OY, Espoo (FI)

(21) Appl. No.: 16/964,150

(22) PCT Filed: Jan. 25, 2019
(86) PCT No.: PCT/EP2019/051813

§ 371 Date: Jul. 22, 2020

(30) Foreign Application Priority Data
Jan. 25, 2018 (EP) 18153376.1

(51) Int. Cl. G01C 21/36; G01C 21/20

(52) U.S. Cl. CPC G01C 21/367; G01C 21/20

(57) ABSTRACT

Methods and apparatuses for determining a location of a cursor on a navigational map are provided. At least one boundary rectangle is calculated for a path on the navigational map, the path comprising at least two waypoints, each waypoint being connected to a next successive waypoint by a respective line segment such that each line segment has two endpoints. A respective segment boundary rectangle is calculated for each line segment along with its two endpoints. A determination in made whether the cursor is located within the at least one boundary rectangle. When the cursor is located within the at least one boundary rectangle, it is determined whether the cursor is located within one of the segment boundary rectangles.

### FIELD

The present application relates generally to navigational maps and, more particularly, to determining cursor location on a navigational map.

### BACKGROUND

Maps can be provided in electronic form. Electronic navigational maps can be used for various purposes. An example is use thereof for path planning for vehicles such as—but not limited to—autonomous vehicles. Another example is use thereof for navigation and/or route planning by a user.

In general, an autonomous vehicle (also referred to as an unmanned vehicle or an unmanned autonomous vehicle) is a vehicle (e.g., a terrestrial drone, an aerial drone) capable of monitoring external information and recognizing a road situation, and capable of autonomously travelling to a target destination along a route (also referred to hereafter interchangeably as a path) planned by itself without human intervention of a vehicle owner.

A route is often a series of two or more waypoints. Some example routing systems (e.g., GPS systems, handheld devices and online map services) may first determine a set of waypoints between a start point and a destination/end point. Next, the routing systems provide for guiding/guidance to a nearest waypoint along the route, then to the next one on a recurring basis until reaching the destination point.

In particular, some online map services may have a feature to create a line path on a navigational map from at least two waypoints by connecting a waypoint to a next following one by a straight line (also referred to hereafter as a line segment), as depicted, for example, in FIG. 1 showing a screenshot of a line path obtained from an electronic map, and more particularly from Google Maps™ mapping service distance measurement tool. As can be seen, multiple distances can be displayed along the whole path. By means of a pointing device (e.g., a mouse, a touchpad or a trackball among others), left-clicking on the navigational map at a location of the pointing device's cursor other than the location of the line segments of the path allows a new waypoint to be created there, and thereby allows the whole path to be extended from the last destination waypoint to that new waypoint. On the other hand, by left-clicking on the navigational map at a location of the cursor that is a line segment of the path, a new waypoint can be created there and the newly created waypoint can be dragged along the line segment until reaching an intermediate location, thereby splitting said line segment in two. Existing waypoints can be selected by left-clicking them and dragged to change their respective location. On the other hand, existing waypoints can be deleted by right-clicking them.

Determining the location of the cursor can be computationally complex operation, and there is a need to improve a cursor location determination.

### SUMMARY

There is provided, according to an aspect, a method for determining a location of a cursor on a navigational map. The method may comprise calculating at least one boundary rectangle for a path on the navigational map, the path comprising at least two waypoints, each waypoint being connected to a next successive waypoint by a respective line segment in such a manner that each line segment has two endpoints, calculating a respective segment boundary rectangle for each line segment along with its two endpoints, determining whether the cursor is located within the at least one boundary rectangle, and determining, when the cursor is located within the at least one boundary rectangle, whether the cursor is located within one segment boundary rectangle amongst the respective segment boundary rectangles.

The method may further comprise a resulting interaction between the cursor and one or more parts of the path amongst the boundary rectangles, the segment boundary rectangles, the waypoints and the corresponding line segments.

The method may further comprise the step of determining, when the cursor is located within one segment boundary rectangle, whether the cursor is located near or within one endpoint inside said one segment boundary rectangle based on a first predetermined distance threshold.

Determining whether the cursor is located near or within one endpoint inside said one segment boundary rectangle may comprise measuring a respective distance between a location of the cursor and each endpoint of the line segment inside said one segment boundary rectangle, comparing the respective distance between the location of the cursor and each endpoint of the line segment inside said one segment boundary rectangle to each other in order to determine the shorter distance corresponding to the distance between the location of the cursor and said one endpoint.

Determining whether the cursor is located near or within one endpoint inside said one segment boundary rectangle may further comprise comparing the shorter distance to the first predetermined distance threshold, the cursor being located near or within said one endpoint when the shorter distance is within the first predetermined distance threshold.

The method may further comprise determining, when the cursor is not located near or within one endpoint inside said one segment boundary rectangle, whether the cursor is located near or within the line segment inside said one segment boundary rectangle based on a second predetermined distance threshold.

Determining whether the cursor is located near or within the line segment inside said one segment boundary rectangle may comprise projecting a location of the cursor to the line segment in order to obtain a projected location of the cursor, measuring a distance between the location of the cursor and the projected location of the cursor and comparing between the location of the cursor and the projected location of the cursor the distance to the second predetermined distance threshold.

The cursor may be located near or within the line segment inside said one segment boundary rectangle when the distance between the location of the cursor and the projected location of the cursor is within the second predetermined distance threshold.

The method may further comprise storing said one segment boundary rectangle in order to obtain a stored segment boundary rectangle.

The method may further comprise checking from a memory if the cursor is within a stored segment boundary rectangle. If so, the stored segment boundary rectangle can be considered active

The method may further comprise locking, when the cursor is located within one segment boundary rectangle, the cursor to said one segment boundary rectangle.

The method may further comprise the step of unlocking, when the cursor is moved to a location away from the stored segment boundary rectangle, the cursor from the stored segment boundary rectangle based on a third predetermined distance threshold.

Unlocking the cursor from the stored segment boundary rectangle may comprise comparing a distance between the location of the cursor and the stored segment boundary rectangle to the third predetermined distance threshold, the cursor being unlocked from the stored segment boundary rectangle when the distance between the location of the cursor and the stored segment boundary rectangle is outside the third predetermined distance threshold and the cursor remaining locked to the stored segment boundary rectangle when the distance between the location of the cursor and the stored segment boundary rectangle is within the third predetermined threshold.

Each boundary rectangle and each segment boundary rectangle may be calculated in minimum and maximum latitude and longitude coordinates, the path being composed of a series of latitude and longitude points.

The path may be split into parts when a length of the path is above a predetermined length threshold, in such a manner as to have one boundary rectangle for the whole path and one segment boundary rectangle for each part of the path.

The parts may be halves of the path.

According to an aspect, there is provided an apparatus comprising means for performing the actions of the method as described above.

According to an aspect, there is provided an apparatus comprising a processor configured to perform the actions of the method as described above.

According to an aspect, there is provided an apparatus comprising at least one processor and at least one memory including a computer program code, the at least one memory and the computer program code being configured to, with the at least one processor, cause the apparatus at least to calculate at least one boundary rectangle for a path on the navigational map, the path comprising at least two waypoints, each waypoint being connected to a next successive waypoint by a respective line segment in such a manner that each line segment has two endpoints; to calculate a respective segment boundary rectangle for each line segment along with its two endpoints; to determine whether the cursor is located within the at least one boundary rectangle; and to determine, when the cursor is located within the at least one boundary rectangle, whether the cursor is located within one segment boundary rectangle amongst the respective segment boundary rectangles.

The apparatus comprising at least one processor and at least one memory including a computer program code, the at least one memory and the computer program code being further configured to, with the at least one processor, cause the apparatus at least to determine, when the cursor is located within one segment boundary rectangle, whether the cursor is located near or within one endpoint inside said one segment boundary rectangle based on a first predetermined distance threshold.

The apparatus comprising at least one processor and at least one memory including a computer program code, the at least one memory and the computer program code being further configured to, with the at least one processor, cause the apparatus at least to determine, when the cursor is not located near or within one endpoint inside said one segment boundary rectangle, whether the cursor is located near or within the line segment inside said one segment boundary rectangle based on a second predetermined distance threshold.

The apparatus comprising at least one processor and at least one memory including a computer program code, the at least one memory and the computer program code being further configured to, with the at least one processor, cause the apparatus at least to store information of said one segment boundary rectangle in a memory in order to obtain a stored segment boundary rectangle. The apparatus may be further configured to cause checking from the memory if the cursor is within the stored segment boundary rectangle. If so, the apparatus may be configured to consider the stored segment boundary rectangle active.

The apparatus may be further configured at least to lock, when the cursor is located within one segment boundary rectangle, the cursor to said one segment boundary rectangle, and to store said one segment boundary rectangle in order to obtain a stored segment boundary rectangle.

The apparatus comprising at least one processor and at least one memory including a computer program code, the at least one memory and the computer program code being further configured to, with the at least one processor, cause the apparatus at least to unlock, when the cursor is moved to a location away from the stored segment boundary rectangle, the cursor from the stored segment boundary rectangle based on a third predetermined distance threshold.

The apparatus according to the second, third and fourth aspects may comprise a display device configured to display a path on a navigational map.

According to a fifth aspect, there is provided a computer program product comprising program instructions for causing a computer to perform the method as described above.

The computer program product may be stored on a medium and may cause an apparatus to perform the method as described herein.

A chipset may comprise any apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically an exemplary screenshot of a line path obtained from a distance measurement tool of an electronic map;

FIG. 2 shows a flow diagram of a procedure for determining a location of a cursor on a navigational map;

FIG. 3 shows schematically an exemplary apparatus capable of supporting control action relating to cursor location;

FIG. 4 shows schematically three line segments along with their respective endpoints which are surrounded by a respective segment boundary rectangle inside one boundary rectangle for a path;

FIG. 5 shows a flow diagram of another example for determining a location of a cursor on a navigational map;

FIG. 6 shows schematically (a): a cursor approaching an active endpoint that becomes highlighted when the cursor is in the vicinity of the active endpoint, and (b): a cursor approaching an active line segment that becomes highlighted when the cursor is in the vicinity of the active line segment;

FIGS. 7a, 7b and 7c show an example of use of stored information in determining cursor location; and

FIG. 8 shows schematically (a): an active line segment being dragged until reaching a target location, and (b): a new waypoint created at the target location and connected between the preceding endpoint and the subsequent endpoint of the dragged line segment by a respective straight line.

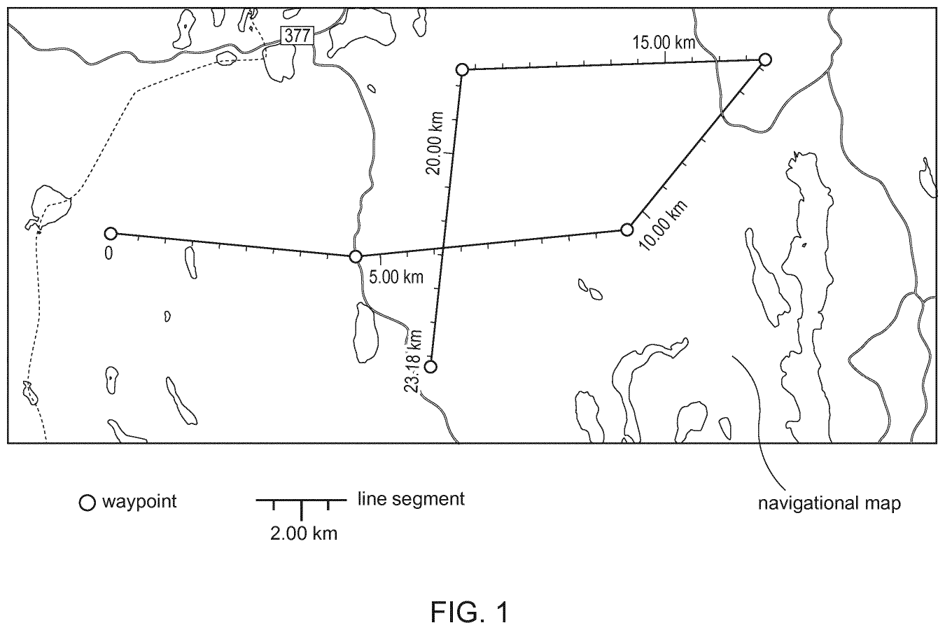

### DETAILED DESCRIPTION

The following describes in further detail a suitable apparatus and possible mechanisms for cursor location determination. The determined location may be used, e.g., for interaction with a line path including multiple waypoints. This can be used e.g. when planning a path for, for example, an autonomous vehicle or otherwise consulting an electronic navigational map and/or planning a path through line manipulation.

In the following, a path may be defined as a line path, namely as a path comprising at least two waypoints and in which a waypoint is connected to a next successive waypoint by a straight line or a line segment (both terms being interchangeable), such that a line path may comprise at least one line segment, i.e., one line segment in the case of two waypoints or a succession of at least two line segments in the case of more than two waypoints. Moreover, the path may be composed of a series of latitude and longitude points.

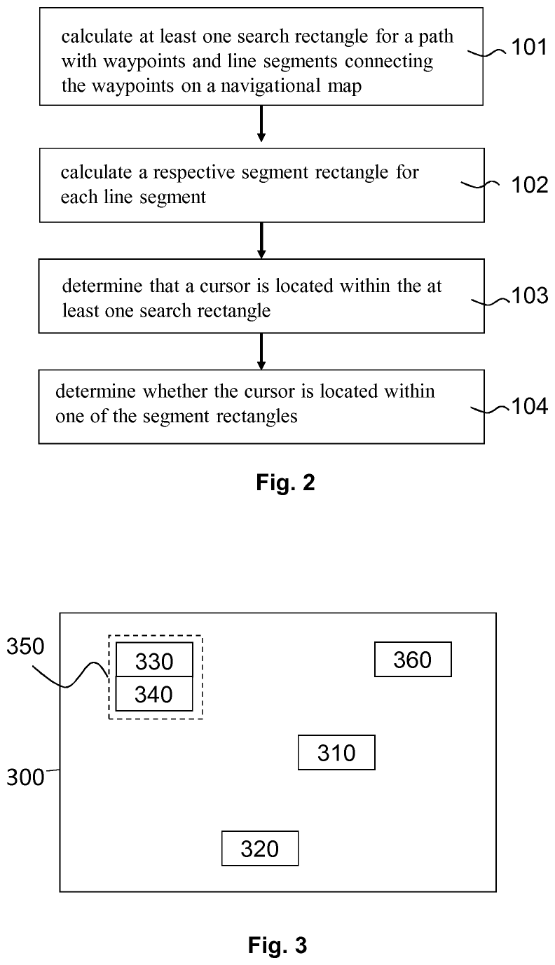

FIG. 2 shows a flow diagram of a procedure for determining a location of a cursor (e.g., a cursor of a pointing device such as a mouse, a touchpad and a trackball among others) on a navigational map. In the shown method for determining a location of the cursor at least one boundary rectangle is calculated at 101 for a path on the navigational map. The rectangle provides a rectangular search window for the operations. The path comprises at least two waypoints such that each waypoint is connected to a next successive waypoint by a respective line segment. Each line segment in turn has two endpoints at the locations of the waypoints. A respective segment boundary rectangle or rectangular window can be calculated at 102 for each of the line segments with two endpoints. It can be determined at 103 whether the cursor is located within the at least one boundary rectangle. If not, the operation based on this rectangle may stop, and another rectangle may be selected. If the cursor is determined to be located within the at least one boundary rectangle, it can then be determined at 104 whether the cursor is located within one of the segment boundary rectangles.

In accordance with a possibility information of the last active boundary segment for the cursor is stored in a memory. When the cursor is moved to new location, the new location coordinates are first compared to the previous stored segment to check if the cursor is still within the segment boundary rectangle, and if not, if the cursor is within the boundary rectangle encompassing the segment boundary rectangle. The stored segment boundary rectangle can be considered as active in response to determining that the cursor is within the stored the segment boundary rectangle. If no such segment is found, the process can be started from the beginning. This type of operation can provide a quick and computationally less demanding way of locating the cursor. This may also improve user experience.

Checking of stored segment boundary rectangles can involve use of thresholds for distances from the previous/stored segment boundary rectangle. In such arrangements, the previous segment can be considered active even if the cursor is determined to be outside the stored segment boundary rectangle but within the threshold.

A predefined number of previously determined segment boundary rectangles may be maintained in the memory and checked against when locating the cursor on the map.

The determination procedures may be implemented by a control apparatus 300 as shown in FIG. 3. The apparatus may comprise concrete hardware circuits having one or more functions of the blocks of the flow diagrams or by a software routine which controls at least one processor (or at least one central processing unit) 310 of a computer to generate the steps of the flow diagram. The hardware circuits or the at least one processor 310 and its corresponding computer may be part of a single apparatus 300 as shown in FIG. 3, or be provided in distributed data processing units. The apparatus may further comprise a user interface (UI) 360 and/or a transceiver 350 comprising a transmitter 330 and a receiver 340.

The steps of the examples described herein may be implemented or performed by the at least one processor 310 and also by corresponding means of the apparatus 300. The apparatus 300 may also comprise at least one memory 320 including a computer program code, and the at least one memory 320 and the computer program code may be configured to, with the at least one processor 310, cause the apparatus 300 to implement or perform the steps as described herein. The at least one processor 310, the at least one memory 320, the transmitter 330, the receiver 340 and/or the user interface (UI) 360 may be interconnected by electrical leads internal to the apparatus 300 in a multitude of different ways.

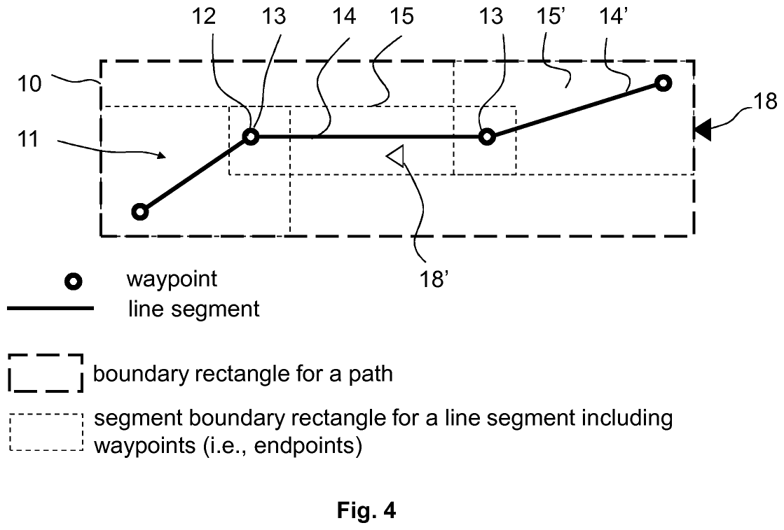

FIG. 4 shows an example of a possible shape arrangement of the rectangles. Rectangle 10 encompasses a path 11 in its entirety. The path is shown to have a plurality of waypoints 12 and line segments 14 between the waypoints. Waypoints 12 at the ends of the line segments 14 also provide end points 13 for each line segment. Segment boundary rectangles 15 are shown to encompass each of the lines segments 14. It is noted that differently shaped windows are also possible as long as the window can be defined in a coordinate system.

In FIG. 4 cursor 18 is determined to be located within the boundary rectangle 10 and also within the segment boundary rectangle 15. This is indicative that the relevant line segment is 14. Distance from the cursor to the line can also be determined before decision that the cursor is above the segment. The filled cursor 18′ is shown as being at the border line of the boundary segment 10 and the segment boundary rectangle 15′. This can be considered as indication that line segment 14′ is relevant.

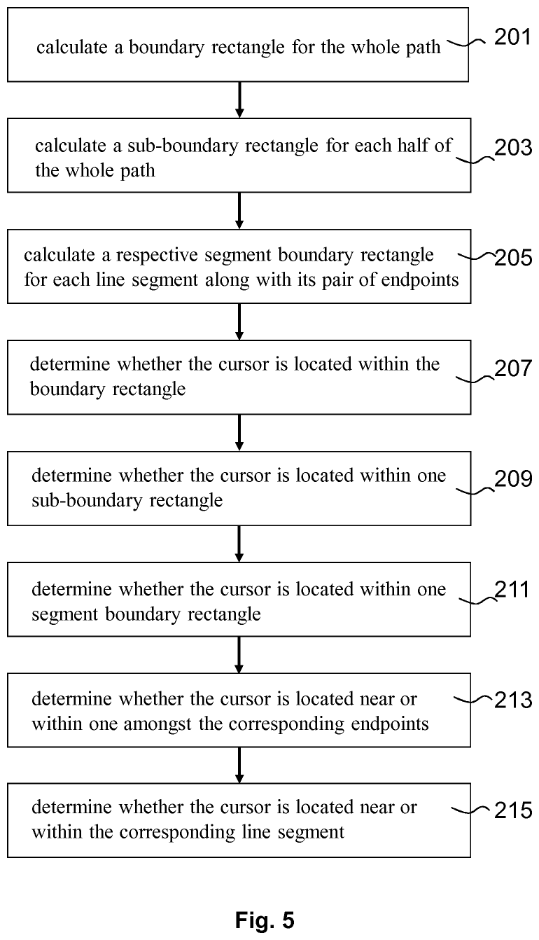

FIG. 5 shows a flow diagram of an example procedure for determining a location of a cursor on a navigational map. The below description of this example with reference to FIGS. 4 and 5 uses the terminology of FIG. 4 for the rectangles.

When a path 11 is created or modified on a navigational map displayed on a screen or a surface video of a display device (e.g., a computer monitor or a touchscreen display among others), a boundary rectangle 10 may be calculated for the whole path in minimum and maximum latitude and longitude coordinates, as shown in FIG. 5 by step 201. Furthermore, when the length of the path is or increases above a predetermined length threshold, then the path may be split into parts. Each part may in turn and repeatedly be split. For example, the path may be split into halves and each half may in turn and repeatedly be split into halves. Thereby, multiple parts of the path (i.e., sub-paths) may be obtained in order to enhance an accuracy of the location of the cursor 18. All these so-obtained sub-paths may then be allocated with a respective boundary rectangle 15 (i.e., a respective sub-boundary rectangle) which may be calculated in minimum and maximum latitude and longitude coordinates, in such a manner that each sub-boundary rectangle comprises at least one line segment 14, step 203. Moreover, when the map is moved on the screen (e.g., a user pans the map on the screen), the corresponding boundary and sub-boundary rectangles may be calculated in (X, Y) screen coordinates.

In turn, each line segment along with its pair of waypoints as endpoints may be allocated with a respective segment boundary rectangle 15 which may be calculated in minimum and maximum latitude and longitude coordinates. This is shown in FIG. 5 by step 205 and illustrated in FIG. 4 showing schematically three line segments along with their respective endpoints 13 which are surrounded by a respective segment boundary rectangle 15 inside one boundary rectangle 10 fora path.

When the cursor 18 is moved on the map (e.g., towards the bottom, middle or top of the map), it may be determined, using, for example, the latitude and longitude coordinates, whether its location is within the boundary rectangle 10 of the whole path 11, as shown in FIG. 5 by step 207. If so, then it may be determined, using, for example, the latitude and longitude coordinates, whether its location is within one amongst the sub-boundary rectangles 14, as shown in FIG. 3 by step 209. If so, then it may be determined, using, for example, the latitude and longitude coordinates, whether its location is within one segment boundary rectangle, as shown in FIG. 5 by step 211.

If the cursor is determined to be located within one of the segment boundary rectangles, then it may be determined, starting with the endpoints 13 of the line segment inside said one segment boundary rectangle 14, whether its location is near or within one endpoint 13, as shown in FIG. 5 by step 213. Otherwise, when the cursor is not located near or within one endpoint inside said one segment boundary rectangle, then it may be determined whether the cursor is located near or within the line segment inside said one segment boundary rectangle, as shown in FIG. 5 by step 215.

The procedure has a benefit of reducing the amount of calculations necessary to determine which element(s) amongst all the boundary rectangles, the endpoints and the line segments is(are) under the cursor, the segment boundary rectangle covering an area smaller than the (sub-)boundary rectangle. However, it shall be noted that, in the case where the cursor is not located within the boundary rectangle of the whole path, then all sub-boundary and segment boundary rectangles, line segments and waypoints may be skipped.

Referring to step 213 of FIG. 5, a respective distance between a location of the cursor and each endpoint of the line segment inside said one segment boundary rectangle may be measured and compared to each other in order to determine the shorter distance, which corresponds to the distance between the location of the cursor and said one endpoint. The shorter distance may then be compared to a first predetermined distance threshold in such a manner that the cursor is determined to be located near or within said one endpoint when the shorter distance is within the first predetermined distance threshold. Said one endpoint may then be considered an active element.

Referring to step 215 of FIG. 5, the location of the cursor may be projected to the line segment inside said one segment boundary rectangle in order to obtain a projected location of the cursor. A distance between the location of the cursor and the projected location of the cursor may then be measured and compared to a second predetermined distance threshold in such a manner that the cursor is determined to be located near or within the line segment inside said one segment boundary rectangle when the distance is within the second predetermined distance threshold. The line segment may then be considered an active element. In an exemplary embodiment, the first and second predetermined distance thresholds may be identical, whereas they may be different in another exemplary embodiment.

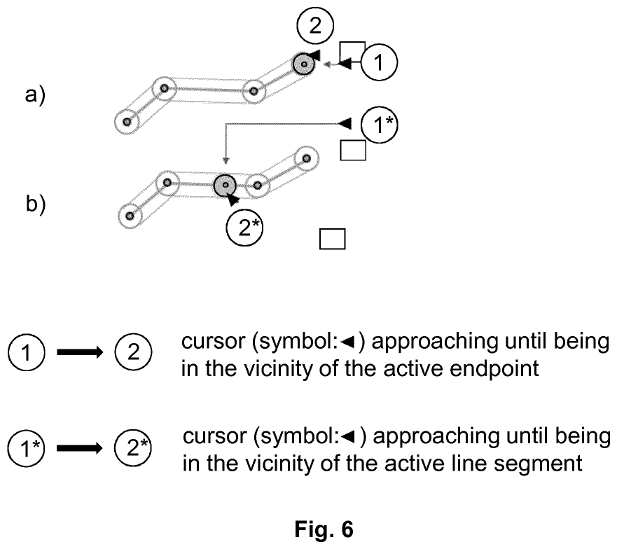

A preview symbol (e.g., a dot, a point or a coloured/hatched area among others) may be drawn on the active element (i.e., either said one endpoint or the line segment) in order to render it readily identifiable as active, as illustrated in FIG. 6. FIG. 6 shows schematically (a): a cursor approaching (1→2) an active endpoint that becomes highlighted (e.g., in grey) when the cursor is in the vicinity of the active endpoint, and (b): a cursor approaching (1*→2*) an active line segment that becomes highlighted (e.g., in grey) when the cursor is in the vicinity of the active line segment.

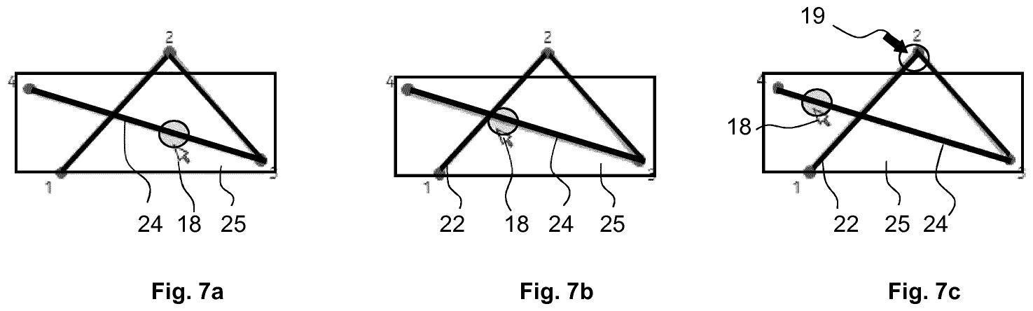

To avoid that the cursor be slipped unintentionally from said one segment boundary rectangle to another segment boundary rectangle of the path to which said one segment boundary rectangle is attached or to another segment boundary rectangle of another path also displayed on the screen, the cursor may be locked to said one segment boundary rectangle within which it lies currently, said one segment boundary rectangle corresponding to the segment boundary rectangle inside which the current active element (i.e., either said one endpoint or the line segment) lies. To perform such locking, said one segment boundary rectangle may be stored in a memory or any suitable storage means of the aforementioned apparatus 300, in order to obtain a stored segment boundary rectangle. An example of this is shown in FIGS. 7a-c. When the cursor 18 is moved from its current location within the stored segment boundary rectangle (25 in FIG. 7) to another location that can be within or away from the stored segment boundary rectangle, a distance between said other location of the cursor and the stored segment boundary rectangle (i.e., the last segment boundary rectangle within which the cursor was located prior to moving) may be compared to a third predetermined distance threshold. When the distance is within the third predetermined threshold, the cursor may then remain locked to the stored segment boundary rectangle and may thereby remain locked to the path (24 in FIG. 7) to which the stored segment boundary rectangle is attached. Thus, the remembrance of the stored segment boundary rectangle and the path attached to that stored segment boundary rectangle may help follow the path (cursor 18 in FIG. 7c) even though there could be a few other crossing paths nearby (Path 22 in FIG. 7). On the other hand, when the distance is outside the third predetermined distance threshold (i.e., the cursor is located far enough from the stored segment boundary rectangle, this being illustrated by cursor 19 in FIG. 7c), the cursor may then be unlocked from the stored segment boundary rectangle and a new search of segment boundary rectangle followed by a new search of active element (i.e., either an endpoint or a line segment) may be achieved according to successive steps 211, 213 and 215 of FIG. 5. According to a possibility a cursor can be within boundary segment rectangles for line segments 24 and 22 if cursor distance is determined to be outside a predetermined distance threshold from line segment 24 associated with the stored rectangle 25, i.e. the cursor does not need to be outside rectangle 25 to be determined be associated with line segment 22. This search associated with the determination steps 211,213 and 215 may allow for a better optimization with respect, for example, to the following consideration stating that a path reacts slowly to the mouse usage and sometimes shows a transfer of map location instead of a creation of a new waypoint when the path is clicked and the mouse is pulled.

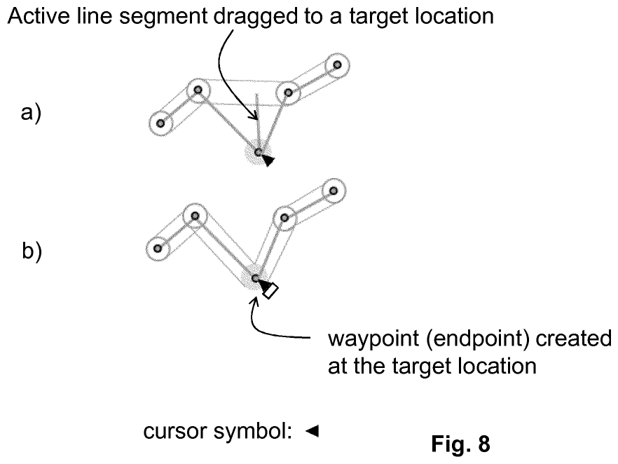

Left-clicking by means of a pointing device (e.g., a mouse) may allow to select the active element, i.e., either an endpoint or a line segment. If the endpoint is active, then left-clicking may also allow to open its possible details for editing, whereas maintaining the left-click and dragging the active endpoint may allow to move the endpoint along or outside the path on the map, i.e., to merely adjust the location of the active endpoint. On the other hand, if the line segment is active, then left-clicking and dragging the active line segment may allow to insert a new waypoint between the endpoints of the line segment, in such a manner that the new waypoint gets connected both to the preceding endpoint and the subsequent endpoint by a respective straight line, the new waypoint being actually inserted by releasing, for example, the mouse button. Thereby, the path may be modified as illustrated in FIG. 8, which shows schematically (a): an active line segment being dragged until reaching a target location, and (b): a new waypoint created at the target location and connected between the preceding endpoint and the subsequent endpoint of the dragged line segment by a respective straight line, according to some embodiments.

Right-clicking by means of the pointing device (e.g., the mouse) may allow to delete an existing waypoint. Thereby, the preceding waypoint and the waypoint being next to the deleted waypoint may get connected by a straight line as a line segment.

In an exemplary embodiment, a preview line may be displayed from the last waypoint to the cursor. This can be used to make it obvious how the path will extend from that last waypoint when an additional waypoint is created. Furthermore, when multiple paths are substantially simultaneously displayed on the screen, this preview line may also allow to substantially immediately identify the active path.

In a further exemplary embodiment, the distances between endpoints of line segment may be displayed not along the whole path but only for the segment boundary rectangle within which the cursor lies. Thereby, the screen may be less cluttered and the planning of line segments may be accurately carried out by the user.

Amongst the waypoints, some of them may provide useful information and be easily found among other waypoints, and, in a further exemplary embodiment, waypoint markers for locations containing commands (e.g., change speed, set region of interest (ROI) or drop payload amongst others) may then be highlighted. For example, an icon may be displayed next to or as part of the waypoint to indicate the type of command at its location.

In a further exemplary embodiment, the endpoints may be displayed with visible dots (i.e., the endpoints may be rendered visible thanks to the dots) when the cursor is hovered over the path. Otherwise, only the start, end and command waypoints are displayed in addition to the line segments along the path. Thereby, the screen may be less cluttered. Furthermore, in an exemplary embodiment, the boundary, sub-boundary and segment boundary rectangles may be invisible on the screen. Thereby, in particular for the segment boundary rectangle, the cursor does not need to be exactly above a line segment but only needs to be brought sufficiently close to the line segment, which may make the usage for a user easier.

In a further exemplary embodiment, the line segments may be animated with dashes, dashed lines or animated points moving in the direction of the path from the start waypoint to the end/destination waypoint. Thereby, a path such as a flight path may be easy to follow even though it appears complicated and even when looking at an arbitrary point on the path. Indeed, the direction of the path may be shown to indicate the next waypoint and/or the end/destination waypoint, for example, by letting the dots flow along the path from the start waypoint to the end/destination waypoint or by showing the dots in sequence, on the path, one by one after each other from the start waypoint to the end/destination waypoint.

It shall be noted that the apparatus 300 may be any suitable electronics device. For example, in some exemplary embodiments, the apparatus 300 may be a mobile device, user equipment, tablet computer, computer and video playback apparatus amongst others.

As above-mentioned, the apparatus 300 may comprise a memory 320 or any suitable storage means. In an exemplary embodiment, the processor of the apparatus 300 may be coupled to the memory 320 or the suitable storage means. In an exemplary embodiment, the memory 320 or the suitable storage means may comprise a program code section for storing program codes implementable upon the processor 310. Furthermore, in an exemplary embodiment, the memory 320 or the suitable storage means may further comprise a stored data section for storing data, for example, data that has been processed or to be processed in accordance with the embodiments as described herein. Such stored data may concern the above-mentioned stored search rectangle and segment rectangle, for example the boundary rectangles. The implemented program code stored within the program code section and the data stored within the stored data section may be retrieved by the processor 310 whenever needed via the memory-processor coupling.

As above-mentioned, in an exemplary embodiment, the apparatus 300 may comprise a user interface (UI) 360. The user interface 360 may be coupled in an exemplary embodiment to the processor 310. In an exemplary embodiment, the processor 310 may control the operation of the user interface 360 and receive inputs from the user interface 360. In an exemplary embodiment, the user interface 360 may enable a user to input commands to the apparatus 300, for example, via a keypad, mouse, touchpad, button or trackball amongst others. In an exemplary embodiment, the user interface 360 may enable the user to obtain information from the apparatus 300. For example, the user interface 360 may comprise a screen or a display or a display device, configured to display information (e.g., about a path on a navigational map, as described herein) from the apparatus 300 to the user. The user interface 360 may, in an exemplary embodiment, comprise a touch screen or a touch interface capable of both enabling information to be entered to the apparatus 300 and further capable of displaying information to the user of the apparatus 300. In an exemplary embodiment, the user interface 360 may be the user interface for communicating with an autonomous vehicle as above-mentioned.

As above-mentioned, in an exemplary embodiment, the apparatus 300 may comprise a transceiver 350. The transceiver 350 in such an embodiment may be coupled to the processor 310 and configured to enable a communication with other apparatuses or electronic devices, for example, via a wireless communications network. The transceiver 350 or any suitable transceiver or transmitter 330 and/or receiver 340 means may, in some exemplary embodiments, be configured to communicate with other electronic devices or apparatuses via a wire or wired coupling.

The transceiver 350 may communicate with a further apparatus by any suitable known communications protocol. For example, the transceiver 350 or transceiver means may use a suitable mobile telecommunications system protocol, a wireless local area network (WLAN) protocol (e.g., IEEE 802.X), a suitable short-range radio frequency communication protocol (e.g., Bluetooth) and an infrared data communication pathway (IRDA) amongst others.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatuses, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor, or by hardware, or by a combination of software and hardware. Further, in this regard, it should be noted that any blocks of the logic flow diagram, e.g., as in FIGS. 2 and 5, may represent program steps, or interconnected logic circuits, blocks and functions, or a combination of program steps and logic circuits, blocks and functions. The software may be stored on such physical media as memory chips, or memory blocks implemented within the processor, magnetic media such as hard disks and floppy disks, and optical media such as, for example, digital video discs (DVDs) and the data variants thereof, compact discs (CDs).

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment and may include one or more of general purpose computers, special purpose computers, microprocessors, digital signal processors (DSPs), application-specific integrated circuits (ASICs), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of exemplary embodiments of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims.

1. A method for determining a location of a cursor on a navigational map, the method comprising:
calculating at least one boundary rectangle for a path on the navigational map, the path comprising at least two waypoints, each waypoint being connected to a next successive waypoint by a respective line segment in such a manner that each line segment has two endpoints;
calculating a respective segment boundary rectangle for each line segment with two endpoints;
determining whether the cursor is located within the at least one boundary rectangle; and
determining, when the cursor is located within the at least one boundary rectangle, whether the cursor is located within one segment boundary rectangle of the respective segment boundary rectangles.

2. The method as claimed in claim 1, further comprising:
determining, when the cursor is located within one segment boundary rectangle, whether the cursor is located near or within one endpoint inside said one segment boundary rectangle based on a first predetermined distance threshold.

3. The method as claimed in claimed 2, wherein determining whether the cursor is located near or within one endpoint inside said one segment boundary rectangle comprises measuring a respective distance between a location of the cursor and each endpoint of the line segment inside said one segment boundary rectangle, comparing the respective distance between the location of the cursor and each endpoint of the line segment inside said one segment boundary rectangle to each other in order to determine the shorter distance corresponding to the distance between the location of the cursor and said one endpoint.

4. The method as claimed in claimed 3, wherein determining whether the cursor is located near or within one endpoint inside said one segment boundary rectangle further comprises comparing the shorter distance to the first predetermined distance threshold, the cursor being located near or within said one endpoint when the shorter distance is within the first predetermined distance threshold.

5. The method as claimed in claim 1, further comprising:
determining, when the cursor is not located near or within one endpoint inside said one segment boundary rectangle, whether the cursor is located near or within the line segment inside said one segment boundary rectangle based on a second predetermined distance threshold.

6. The method as claimed in claim 5, wherein determining whether the cursor is located near or within the line segment inside said one segment boundary rectangle comprises projecting a location of the cursor to the line segment in order to obtain a projected location of the cursor, measuring a distance between the location of the cursor and the projected location of the cursor and comparing the distance between the location of the cursor and the projected location of the cursor to the second predetermined distance threshold.

7. The method as claimed in claimed 6, wherein the cursor is located near or within the line segment inside said one segment boundary rectangle when the distance between the location of the cursor and the projected location of the cursor is within the second predetermined distance threshold.

8.-14. (canceled)

15. An apparatus for determining a location of a cursor on a navigational map, the apparatus comprising at least one processor and at least one memory including computer program code, the at least one memory and the computer program code configured to, with the at least one processor, cause the apparatus at least to perform:
calculating at least one boundary rectangle for a path on the navigational map, the path comprising at least two waypoints, each waypoint being connected to a next successive waypoint by a respective line segment in such a manner that each line segment has two endpoints;
calculating a respective segment boundary for each line segment with two endpoints;
determining whether the cursor is located within the at least one boundary rectangle; and
determining, when the cursor is located within the at least one boundary rectangle, whether the cursor is located within one segment boundary rectangle of the respective segment boundary rectangles.

16. The apparatus as claimed in claim 15, further configured to cause determining, when the cursor is located within one segment boundary rectangles, whether the cursor is located near or within one endpoint inside said one segment boundary rectangle based on a first predetermined distance threshold.

17. The apparatus as claimed in claim 16, further configured to, when determining whether the cursor is located near or within one endpoint inside said one segment boundary rectangle, cause measuring a respective distance between a location of the cursor and each endpoint of the line segment inside said one segment boundary rectangle, comparing the respective distance between the location of the cursor and each endpoint of the line segment inside said one segment boundary rectangle to each other in order to determine the shorter distance corresponding to the distance between the location of the cursor and said one endpoint.

18. The apparatus as claimed in claim 17, further configured to, when determining whether the cursor is located near or within one endpoint inside said one segment boundary rectangle, cause comparing the shorter distance to the first predetermined distance threshold, the cursor being located near or within said one endpoint when the shorter distance is within the first predetermined distance threshold.

19. The apparatus as claimed in claim 15, further configured to cause determining, when the cursor is not located near or within one endpoint inside said one segment boundary rectangle, whether the cursor is located near or within the line segment inside said one segment boundary rectangle based on a second predetermined distance threshold.

20. The apparatus as claimed in claim 19, further configured to, when determining whether the cursor is located near or within the line segment inside said one segment boundary rectangle, cause projecting a location of the cursor to the line segment in order to obtain a projected location of the cursor, measuring a distance between the location of the cursor and the projected location of the cursor and comparing the distance between the location of the cursor and the projected location of the cursor to the second predetermined distance threshold.

21. The apparatus as claimed in claim 20, further configured to determine that the cursor is located near or within the line segment inside said one segment boundary rectangle when the distance between the location of the cursor and the projected location of the cursor is within the second predetermined distance threshold.

22. The apparatus as claimed in claim 15, further configured to cause storing information of said one segment boundary rectangle in a memory in order to obtain a stored segment boundary rectangle.

23. The apparatus as claimed in claim 22, further configured to cause checking from the memory if the cursor is within the stored segment boundary rectangle, and if so, considering the stored segment boundary rectangle active.

24. The apparatus as claimed in claim 22, further configured to cause locking the cursor to one stored segment boundary rectangle.

25. The apparatus as claimed in claim 17, further configured to cause unlocking, when the cursor is moved to a location away from the stored segment boundary rectangle, the cursor from the stored segment boundary rectangle based on a third predetermined distance threshold.

26. The apparatus as claimed in claim 25, further configured to, when unlocking the cursor from the stored segment boundary rectangle, cause comparing a distance between the location of the cursor and the stored segment boundary rectangle to the third predetermined distance threshold, the cursor being unlocked from the stored segment boundary rectangle when the distance between the location of the cursor and the stored segment boundary rectangle is outside the third predetermined distance threshold and the cursor remaining locked to the stored segment boundary rectangle when the distance between the location of the cursor and the stored segment boundary rectangle is within the third predetermined threshold.

27. The apparatus as claimed in claim 15, further configured to calculate each boundary rectangle and each segment boundary rectangle in minimum and maximum latitude and longitude coordinates, the path being composed of a series of latitude and longitude points.

28.-29. (canceled)
